(19) United States
(12) Patent Application Publication
(10) Pub. No.: US 2012/0149365 A1
(43) Pub. Date: Jun. 14, 2012

(54) VEHICLE INFORMATION SYSTEM

(75) Inventors: Yilun Ying, Shanghai (CN); Chao Fang, Shanghai (CN); Yang Luan, Shanghai (CN); Chao Xu, Shanghai (CN); Dawei Zhu, Shanghai (CN); Song Yang, Shanghai (CN)

(73) Assignees: Shanghai PATEO Internet Technology Service Co., Ltd., Shanghai (CN); Shanghai PATEO Electronic Equipment Manufacturing Co., Ltd., Shanghai (CN)

(21) Appl. No.: 13/391,738

(22) PCT Filed: Dec. 25, 2010
(86) PCT No.: PCT/CN2010/080283

§ 371 Date: Feb. 22, 2012

(30) Foreign Application Priority Data
Dec. 31, 2009 (CN) 200910247981.9

(51) Int. Cl. H04W 4/04

(52) U.S. Cl. 455/426.1

(57) ABSTRACT

A vehicle information system includes: a vehicle-mounted device, a voice service system and a service center which is adapted for providing service data. A first service channel system is configured between the voice service system and the vehicle-mounted device, and adapted for transmitting voice data. A second service channel is configured between the voice service system and the service center, and adapted for transmitting configuration data which is adapted for configuring the service data that are provided for the vehicle-mounted device. And the second service channel is established on basis of connection to internet. A third service channel system is configured between the service center and the vehicle-mounted device. A complete solution for providing real-time information service may be provided by the vehicle information system, thereby improving the quality of user experience while using a vehicle.

### CROSS REFERENCE TO RELATED APPLICATIONS

The present application claims the priority of Chinese Patent Application No. 200910247981.9, entitled “Vehicle Information System”, and filed on Dec. 31, 2009, the entire disclosure of which is incorporated herein by reference.

### BACKGROUND OF THE INVENTION

1. Field of the Invention

The present invention relates to the field of vehicle electronic technology, and particularly relates to a vehicle information system.

2. Background of the Invention

Nowadays, vehicle industry is developing rapidly, and the quantity of vehicles is continuously increasing. When using a vehicle, people pay more attention to the user experience. Multimedia information such as music, video and pictures, and driving information such as real-time state of the road and maps of destinations are required.

In prior art, driving information can be provided by GPS (Global Position System) navigation devices, and needs for multimedia information such as music, video and pictures can be met by playing optical disks which contain these multimedia information. Updating of these multimedia information may be usually realized by changing the disks, however, real-time updating may not be achieved.

Currently, some multimedia entertainment systems, in which Bluetooth technique is adopted, are mounted in vehicles. For example, a multimedia playing device is disclosed in Chinese Patent No. 200720171205.1, wherein a vehicle-mounted audio/video playing device may play audio/video which is obtained from an external Bluetooth terminal by using Bluetooth technique. However, the multimedia playing device can not provide a real-time multimedia information service for the vehicle users. Further, as it is realized based on Bluetooth technique, the coupling method thereof is limited.

Besides, there is no complete solution for providing diverse information services during using vehicles.

### SUMMARY OF THE INVENTION

An object of the invention is to provide a vehicle information system, which offers a complete solution for providing real-time information service during using vehicles.

To achieve the objection, an embodiment of the present invention provides a vehicle information system, including: a vehicle-mounted device, a voice service system and a service center which is adapted for providing service data.

A first service channel system is configured between the voice service system and the vehicle-mounted device and is adapted for transmitting voice data.

A second service channel is configured between the voice service system and the service center and is adapted for transmitting configuration data which are adapted for configuring the service data that are provided for the vehicle-mounted device. The second service channel is established on basis of connection to internet.

A third service channel system is configured between the service center and the vehicle-mounted device.

An embodiment of the present invention provides another vehicle information system, including: a vehicle-mounted device, a voice service system and a service center which is adapted for providing service data.

A first service channel system is configured between the voice service system and the vehicle-mounted device and is adapted for transmitting voice data and the service data.

A second service channel is configured between the voice service system and the service center and is adapted for transmitting the service data and configuration data. The configuration data are adapted for configuring the service data that are provided for the vehicle-mounted device. The second service channel is established on basis of connection to internet.

Compared with prior art, the vehicle information system according to embodiments of present invention has the following advantages. The service data provided by the service center are configured by the voice service system. The service data which may be provided from the service center may be configured in advance according to possible needs of the vehicle users or obtained by gathering relevant information of the vehicle users. Thereafter, the vehicle-mounted device may obtain the configured service from the service center. Therefore, a complete solution for providing real-time information service may be provided by the vehicle information system, thereby improving the quality of user experience while using a vehicle.

### BRIEF DESCRIPTION OF THE DRAWINGS

FIG. 1 is a schematic diagram of a vehicle information system according to a first embodiment of the present invention;

FIG. 2 is a schematic diagram of a first example of a vehicle information system according to the first embodiment of the present invention;

FIG. 3 is a schematic diagram of an example of a first mobile communication network device in the vehicle information system shown in FIG. 2 according to an embodiment of the present invention;

FIG. 4 is a schematic diagram of an example of a second mobile communication network device in the vehicle information system shown in FIG. 2 according to an embodiment of the present invention;

FIG. 5 is a schematic diagram of an example of a communication unit of a vehicle-mounted device in the vehicle information system shown in FIG. 2 according to an embodiment of the present invention;

FIG. 6 is a schematic diagram of a vehicle information system according to a second embodiment of the present invention; and

FIG. 7 is a schematic diagram of a second example of a vehicle information system according to the second embodiment of the present invention.

### DETAILED DESCRIPTION OF THE EMBODIMENTS

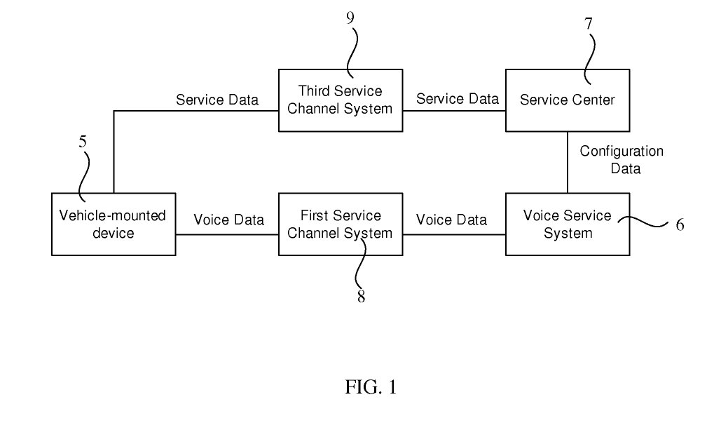

Referring to FIG. 1, a vehicle information system according to a first embodiment of the present invention includes: a vehicle-mounted device 5, a voice service system 6 and a service center 7 which is adapted for providing service data.

A first service channel system 8 is configured between the voice service system 6 and the vehicle-mounted device 5 and is adapted for transmitting voice data.

A second service channel is configured between the voice service system 6 and the service center 7 and is adapted for transmitting configuration data which are adapted for configuring the service data for the vehicle-mounted device 5. The second service channel is established on basis of connection to internet.

A third service channel system 9 is configured between the service center 7 and the vehicle-mounted device 5.

As an embodiment, the voice service system 6 acts as a service requesting terminal of the vehicle information system, the service center 7 acts as a service providing terminal of the vehicle information system, and the vehicle-mounted device 5 acts as a service receiving terminal of the vehicle information system. Specifically, the service data which are provided from the service center 7 to the vehicle-mounted device 5 are determined by the voice service system 6 according to the configuration data. Thereafter, the vehicle-mounted device 5 may obtain the service data which are provided by the service center 7 through the third service channel system 9.

As an embodiment, in practice, the voice service system 6 may be a customer relationship management system (CRM) or a call center system.

Hereinafter, the first embodiment of the vehicle information system is further illustrated in an example accompany with attached drawings.

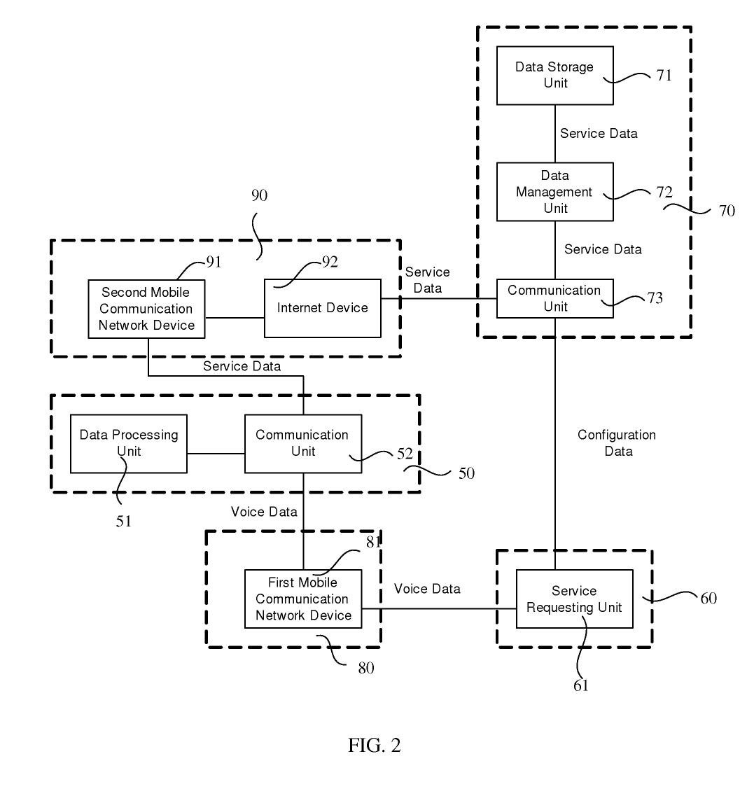

Referring to FIG. 2, in a first example of the vehicle information system according to the first embodiment of the present invention, a vehicle-mounted device 50 may include:

A communication unit 52, adapted for interchanging data between the vehicle-mounted device 50 and a voice service system 60 or between the vehicle-mounted device 50 and a service center 70; and

A data processing unit 51, adapted for processing data that are to be transmitted to the voice service system 60, and receiving and processing data from the service center 70.

A first service channel system 80 may include a first mobile communication network device 81 which is adapted for transmitting voice data between the voice service system 60 and the vehicle-mounted device 50.

The voice service system 60 may include: a service requesting unit 61 which is adapted for generating a service request according to the voice data and transmitting the service request to the service center 70.

The service center 70 may include:

A communication unit 73, adapted for interchanging data between the service center 70 and the voice service system 60 or between the service center 70 and the vehicle-mounted device 50;

A data storage unit 71, adapted for storing service data; and

A data management unit 72, adapted for acquiring the service data from the data storage unit 71 according to configuration data, and transmitting the service data to the vehicle-mounted device 50.

A third service channel system 90 may include:

A second mobile communication network device 91, adapted for coupling the vehicle-mounted device 50 to internet; and

An internet device 92, adapted for establishing connection between the vehicle-mounted device 50 and the service center 70.

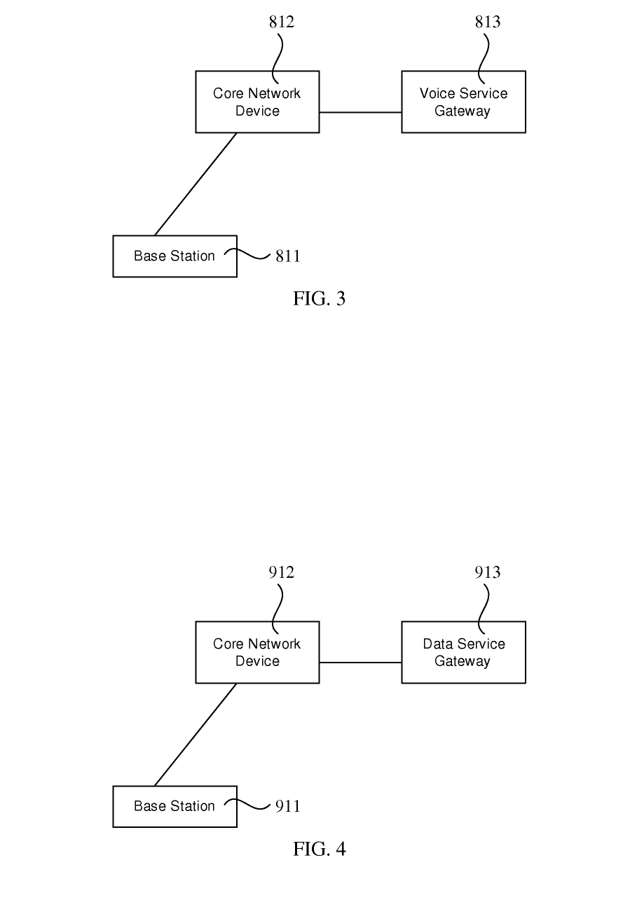

Referring to FIG. 3, the first mobile communication network device may include: a base station 811, a core network device 812 and a voice service gateway 813.

Referring to FIG. 2 in conjunction with FIG. 3, when a vehicle user has a need for information service, a first service request for voice communication is transmitted by the communication unit 52 in the vehicle-mounted device 50. Upon obtaining the first service request, the base station 811 transmits the first service request to the core network device 812. After the first service request is processed, a voice data transmission occurs between the vehicle-mounted 50 and the voice service system 60 through the voice service gateway 813.

Thereafter, the service requesting unit 61 in the voice service system 60 generates a second service request according to the voice data and transmits the second service request to the service center 70. The second service request is transmitted to the data management unit 72. Upon obtaining the second service request, the data management unit 72 acquires the relevant service data from the data storage unit 71 and transmits the service data through the communication unit 73. The service data stored in the data storage unit 71 may be configured in advance according to the possible needs of the vehicle user. For example, if the user needs GPS navigation service, the service data may include map data, real-time state of road data and road book data. For another example, if the user needs multimedia entertainment service, the service data may include data of music, video and pictures and so on. For still another example, if the user needs information of vehicle operation, the service data may include vehicle operation course and vehicle driving record.

As an example, if the vehicle user needs the GPS navigation service, the data management unit 72 would acquire and transmit the map data, the real-time state of road data and the road book data corresponding to the user's destination from the data storage unit 71.

As a service receiving terminal, the vehicle-mounted device 50 may obtain the service data provided by the service center 70 through the third service channel system 90.

Referring to FIG. 4, the second mobile network device may include: a base station 911, a core network device 912 and a data service gateway 913.

Referring to FIG. 2 in conjunction with FIG. 4, a third service request for accessing to internet is transmitted by the vehicle-mounted device 50 through the communication unit 52. Upon obtaining the third service request, the base station 911 transmits the third service request to the core network device 912. The core network device 912 couples the vehicle-mounted device 50 to internet through the data service gateway 913 after a relevant process. Thereafter, the internet device 92 couples the vehicle-mounted device 50 which is already on internet to the service center 70. Therefore, the vehicle-mounted device 50 may obtain the service data which are provided by the service center 70.

Since the vehicle-mounted device 50 is coupled to internet through the mobile communication network device, accordingly, the vehicle-mounted device 50 obtains the service data which are provided by the service center 70 through the mobile communication network device. However, the data format which is recognizable to the vehicle-mounted device 50 may not comply with the data format which is in compliance with mobile communication network transmission protocols, therefore, the service data format needs to be transformed in order to be recognizable to the vehicle-mounted device. Transforming the data format may be performed by the communication unit 52 in the vehicle-mounted device 50.

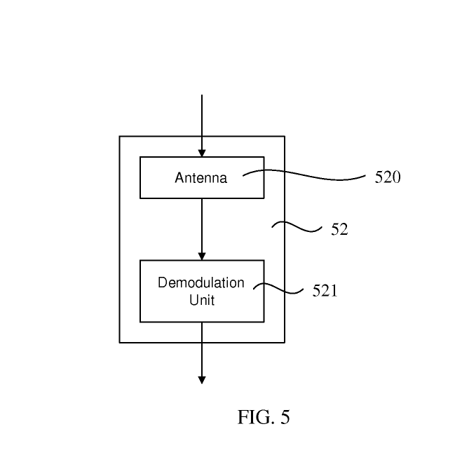

Referring to FIG. 2 in conjunction with FIG. 5, the communication unit may include:

An antenna 520; and

A demodulation unit 521, adapted for transforming the data format of the service data from the service center 70 into a data format which is recognizable to the vehicle-mounted device.

As an example, if the mobile communication network is a 2.5G network, the demodulation unit 521 needs to transform the obtained data, with a data format in compliance with the 2.5G network transmission protocol, into data with a data format which is recognizable to the vehicle-mounted device. In an embodiment, service data which are adapted for playing video are transformed into data with an existing mainstream video format, for example, “.rm”, “.avi”, or “.mkv”. Service data which are adapted for playing audio are transformed into data with an existing mainstream audio format, for example, “.mp3”, “.wav”, or “.wma”. Service data which are adapted for showing pictures are transformed into data with an existing mainstream picture format, for example, “.bmp”, “.jpeg”, or “.gif”.

In the aforementioned embodiment, the vehicle-mounted device may obtain the service data through the service center. In another embodiment of the present invention, the vehicle-mounted device may obtain the service data through the voice service system.

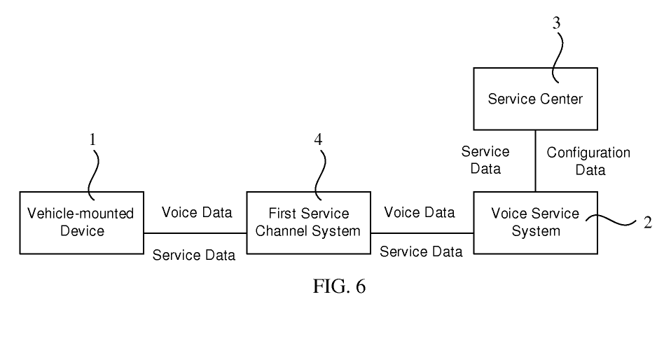

Referring to FIG. 6, a vehicle information system according to a second embodiment of the present invention includes: a vehicle-mounted device 1, a voice service system 2 and a service center 3 which is adapted for providing service data.

A first service channel system 4 is configured between the voice service system 2 and the vehicle-mounted device 1 and is adapted for transmitting voice data and the service data.

A second service channel is configured between the voice service system 2 and the vehicle-mounted device 1 and is adapted for transmitting configuration data and the service data. The configuration data are adapted for configuring the service data which are provided for the vehicle-mounted device 1. The second service channel is established on basis of connection to internet.

As an embodiment, the voice service system 2 acts as a service requesting terminal and a final service providing terminal of the vehicle information system, the service center 3 acts as an initial service providing terminal of the vehicle information system, and the vehicle-mounted device 1 acts as a service receiving terminal of the vehicle information system. Specifically, the voice service system 2 determines the service data provided by the service center 3 according to the configuration data, and obtains the corresponding service data from the service center 3. Thereafter, the obtained service data are transmitted to the vehicle-mounted device 1 by the voice service system 2.

As an embodiment, in practice, the voice service system 2 may be as a customer relationship management system (CRM) or a call center system.

Hereinafter, the vehicle information system according to the second embodiment is further illustrated in an example accompany with attached drawings.

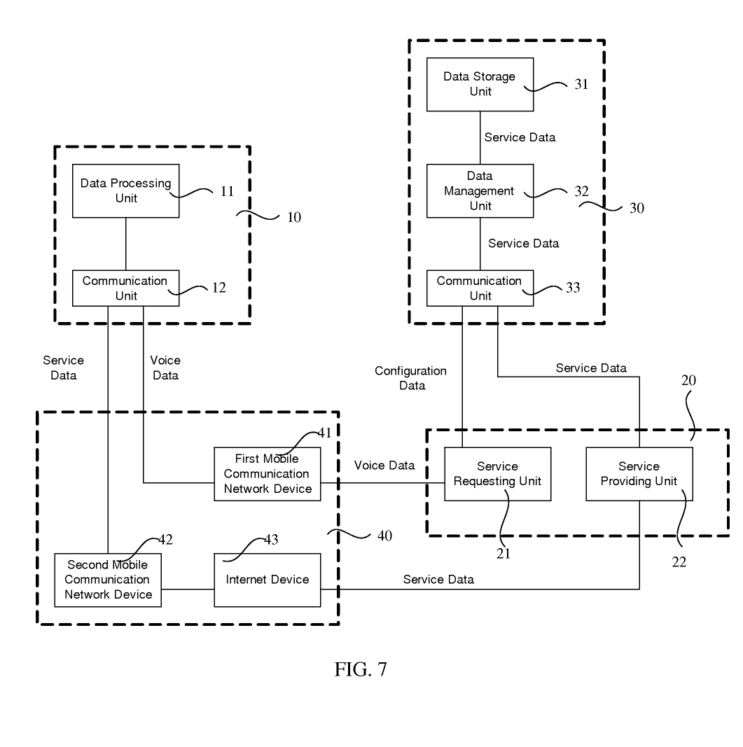

Referring to FIG. 7, in a second example of the vehicle information system according to the second embodiment of the present invention, a vehicle-mounted device 10 may include:

A communication unit 12, adapted for interchanging data between the vehicle-mounted device 10 and a voice service center 20.

A data processing unit 11, adapted for processing data that are to be transmitted to the voice service system 20, and receiving and processing data from the voice service system 20.

A first service channel system 40 may include:

A first mobile communication network device 41, adapted for transmitting voice data between the voice service system 20 and the vehicle-mounted device 10;

A second mobile communication network device 42, adapted for coupling the vehicle-mounted device 10 to internet; and

An internet device 43, adapted for establishing connection between the vehicle-mounted device 10 and the voice service center 20.

The voice service system 20 may include:

A service requesting unit 21, adapted for generating a service request according to the voice data and transmitting the service request to a service center 30; and a service providing unit 22, adapted for transmitting service data to the vehicle-mounted device 10.

The service center 30 may include:

A communication unit 33, adapted for interchanging data between the service center 30 and the voice service system 20;

A data storage unit 31, adapted for storing service data; and

A data management unit 32, adapted for acquiring the service data from the data storage unit 31 according to configuration data, and transmitting the service data to the voice service center 20.

Compared with the first example of the vehicle information system according to the first embodiment, in the second example of the vehicle information system according to the second embodiment, the voice service system acts as both a service requesting terminal and a final service providing terminal. The service data which are in response to the service request are firstly transmitted to the voice service system 20, and then transmitted to the vehicle-mounted device 10 by the voice service system 20. Functions and structures of the first mobile communication network device, the second mobile communication network device and the internet device corresponding to the data transmissions are similar to those of the relevant devices in the first example. Data processing related with the second example may be referred to those descriptions in the first example, which will not be illustrated in detail herein.

In conclusion, in the vehicle information system according to the embodiments of the present invention, the service data provided by the service center are configured by the voice service system, and the service data which may be provided by the service center may be configured in advance according to possible needs of vehicle users or obtained by gathering relevant information of the vehicle users. Thereafter, the vehicle-mounted device obtains the configured service from the service center. Therefore, a complete solution for providing real-time information service may be provided by the vehicle information system, thereby improving the quality of user experience while using a vehicle.

Although the present invention has been disclosed as above with reference to preferred embodiments, it is not intended to limit the present invention. Those skilled in the art may modify and vary the embodiments without departing from the spirit and scope of the present invention. Accordingly, the scope of the present invention shall be defined in the appended claims.

1. A vehicle information system, comprising:
a vehicle-mounted device, a voice service system and a service center which is adapted for providing service data;
a first service channel system, configured between the voice service system and the vehicle-mounted device, and adapted for transmitting voice data;
a second service channel, configured between the voice service system and the service center, and adapted for transmitting configuration data which are adapted for configuring the service data for the vehicle-mounted device, and established on basis of connection to internet; and
a third service channel system, configured between the service center and the vehicle-mounted device.

2. The vehicle information system according to claim 1, wherein the first service channel system comprises a first mobile communication network device which is adapted for transmitting the voice data between the voice service system and the vehicle-mounted device.

3. The vehicle information system according to claim 2, wherein the first mobile communication network device comprises: a base station, a core network device and a voice service gateway.

4. The vehicle information system according to claim 1, wherein the third service channel system comprises:
a second mobile communication network device, adapted for coupling the vehicle-mounted device to internet; and
an internet device, adapted for establishing connection between the vehicle-mounted device and the service center.

5. The vehicle information system according to claim 4, wherein the second mobile communication network device comprises: a base station, a core network device and a data service gateway.

6. The vehicle information system according to claim 1, wherein the voice service system comprises: a service requesting unit, adapted for generating a service request according to the voice data and transmitting the service request to the service center, wherein the service data are transmitted from the service center to the vehicle-mounted device according to the service request.

7. The vehicle information system according to claim 1, wherein the vehicle-mounted device comprises:
a communication unit, adapted for interchanging data between the vehicle-mounted device and the voice service system or between the vehicle-mounted device and the service center; and
a data processing unit, adapted for processing data that are to be transmitted to the voice service system, and receiving and processing data from the service center.

8. The vehicle information system according to claim 7, wherein the communication unit comprises a demodulation unit which transforms the service data received from the service center into data with a format which is recognizable to the vehicle-mounted device.

9. The vehicle information system according to claim 1, wherein the service center comprises:
a communication unit, adapted for interchanging data between the service center and the voice service system or between the service center and the vehicle-mounted device;
a data storage unit, adapted for storing the service data; and
a data management unit, adapted for acquiring the service data from the data storage unit according to the configuration data and transmitting the service data to the vehicle-mounted device.

10. The vehicle information system according to claim 1, wherein the service data comprises data of map, real-time state of road, road book, music, video, picture, vehicle operation course and vehicle driving record.

11. A vehicle information system, comprising: a vehicle-mounted device, a voice service system and a service center which is adapted for providing service data;
a first service channel system, configured between the voice service system and the vehicle-mounted device, and adapted for transmitting voice data and the service data; and
a second service channel, configured between the voice service system and the service center, and adapted for transmitting the service data and configuration data which are adapted for configuring the service data that are provided for the vehicle-mounted device, and established on basis of connection to internet.

12. The vehicle information system according to claim 11, wherein the first service channel system comprises:
a first mobile communication network device, adapted for transmitting the voice data between the voice service system and the vehicle-mounted device;
a second mobile communication network device, adapted for coupling the vehicle-mounted device to internet; and
an internet device, adapted for establishing connection between the vehicle-mounted device and the service center.

13. The vehicle information system according to claim 12, wherein the first mobile communication network device comprises: a base station, a core network device and a voice service gateway.

14. The vehicle information system according to claim 12, wherein the second mobile communication network device comprises: a base station, a core network device and a data service gateway.

15. The vehicle information system according to claim 11, wherein the voice service system comprises: a service requesting unit, adapted for generating a service request according to the voice data and transmitting the service request to the service center; a service providing unit, adapted for providing the service data for the vehicle-mounted device, wherein the service data are transmitted from the service center to the voice service system according to the service request.

16. The vehicle information system according to claim 11, wherein the vehicle-mounted device comprises:
a communication unit, adapted for interchanging data between the vehicle-mounted device and the voice service system; and
a data processing unit, adapted for processing data which are to be transmitted to the voice service system, and receiving and processing data from the voice service system.

17. The vehicle information system according to claim 16, wherein the communication unit comprises a demodulation unit, the demodulation unit transforms the service data from the voice service system into data with a format which is recognizable to the vehicle-mounted device.

18. The vehicle information system according to claim 11, wherein the service center comprises:
a communication unit, adapted for interchanging data between the service center and the voice service system;
a data storage unit, adapted for storing the service data; and
a data management unit, adapted for acquiring the service data from the data storage unit according to the configuration data and transmitting the service data to the voice service system.

19. The vehicle information system according to claim 11, wherein the service data comprises data of map, real-time state of road, road book, music, video, picture, vehicle operation course and vehicle driving record.
